(19) United States
(12) Patent Application Publication
(10) Pub. No.: US 2020/0293977 A1
(43) Pub. Date: Sep. 17, 2020

(54) SYSTEM AND METHOD FOR CONCURRENT PROCESSING OF WORK ITEMS

(71) Applicant: Genesys Telecommunications Laboratories, Inc., Daly City, CA (US)

(72) Inventors: Jason Carter, Carmel, IN (US); Jaclyn Spillane, Zionsville, IN (US); Carl Fluke, Indianapolis, IN (US); David Ham, McCordsville, IN (US); Charles E. Bowman, Zionsville, IN (US)

(21) Appl. No.: 16/351,660

(22) Filed: Mar. 13, 2019

(51) Int. Cl. G06Q 10/06

(52) U.S. Cl. CPC G06Q 10/063116; G06Q 10/063114; G06Q 10/06314; G06Q 10/063112; G06Q 10/06316

(57) ABSTRACT

A system and method are presented for concurrent processing of work items by a plurality of human resources. A work item request is received in the system by an intelligent process automation module which sends a notification of the request to a plurality of human resources. Each of the plurality of human resources can evaluate and perform an action against the request through the module. Information related to the request may be examined by several of the plurality of human resources concurrently. The plurality of human resources may also perform actions on the request at the same time with the request also being simultaneously updated with these actions. Stateful information of those individuals who are not owners of the request may not be affected and they may still perform actions, edits, or receive notifications on the work items.

### BACKGROUND

The present invention generally relates to telecommunications systems and methods, as well as workflow management. More particularly, the present invention pertains to the concurrent processing of items in a workflow.

### SUMMARY

A system and method are presented for concurrent processing of work items by a plurality of human resources. A work item request is received in the system by an intelligent process automation module which sends a notification of the request to a plurality of human resources. Each of the plurality of human resources can evaluate and perform an action against the request through the module. Information related to the request may be examined by several of the plurality of human resources concurrently. The plurality of human resources may also perform actions on the request at the same time with the request also being simultaneously updated with these actions. Stateful information of those individuals who are not owners of the request may not be affected and they may still perform actions, edits, or receive notifications on the work items.

In one embodiment, a method is presented for non-linear routing of work items, wherein a plurality of human resources are capable of concurrently processing the work items in a system across a network in an enterprise setting, the method comprising: submitting, by a first party through a user interface, a work item to a processor comprising an intelligent process automation module; collecting information related to the work item and determining the availability of qualified human resources from the plurality of human resources; entering the work item into the system if it has been determined that there is availability of qualified human resources, otherwise returning the work item to the first party; performing, by the plurality of human resources, state change actions to the work item, wherein the actions are performed concurrently by the plurality of human resources; comparing a last modified record timestamp for each of the plurality of human resources on the work item to a last known modified timestamp of a server for the state change action, wherein, if the values do not match, alert the human resource and force a re-evaluation of the requested state change; and updating the work item with the action until the work item has been handled.

Information comprises one or more of: skills required of the qualified human resources; availability of the qualified human resources to handle the work item; and subject matter expertise of the qualified human resources.

The availability of qualified human resources is compared against a threshold and if there is no availability, the work item is returned to the first party for selection of a new attribute. Additionally, the availability of qualified human resources is compared against a threshold and if it does not meet a threshold, a notification is generated to one or more of the: first party and the plurality of human resources.

The plurality of human resources are associated with at least one of: a group having a specific skillset; a specific queue; a specific workgroup; a specific business unit; and, a logical grouping of human resources. The availability of the plurality of human resources is pulled from the personal information manager systems of the human resources.

The state change actions comprise at least one of: view list of a plurality of work items; view list of a plurality of human resources; view a single work item; and, actions performed by a human resource. The view list of a plurality of work items is periodically refreshed. The view list comprises a view of a personal queue associated with a human resource. The single work item view comprises viewing a representation of the work item that the human resource receives. The view list comprises a view of a personal queue associated with a human resource. The single work item view comprises viewing a representation of the work item that the human resource receives. Actions performed by a human resource comprise one or more of: edit work item; reschedule work item; cancel; accept work item; and, decline. The acceptance of a work item comprises assignment of the work item. The acceptance of a work item changes the state of the work item to accepted. The acceptance of a work item triggers an action item by the system. The action item comprises one or more: notifying the first party; creating calendar events; notifying the accepting human resource; and, updating data associated with the work item in the system.

In another embodiment, a system is presented for non-linear routing of work items, wherein a plurality of human resources are capable of concurrently processing the work items in a system across a network in an enterprise setting, the method comprising: a processor, comprising an intelligent process automation module to which a work item is submitted by a first party through a user interface; and, a memory in communication with the processor, the memory storing instructions that, when executed by the processor, causes the processor to: collect information related to the work item and determine the availability of qualified human resources from the plurality of human resources; enter the work item into the system if it has been determined that there is availability of qualified human resources, otherwise returning the work item to the first party; perform state change actions to the work item, wherein the actions are performed concurrently by the plurality of human resources; compare a last modified record timestamp for each of the plurality of human resources on the work item to a last known modified timestamp of a server for the state change action, wherein, if the values do not match, alert the human resource and force a re-evaluation of the requested state change; and update the work item with the action until the work item has been handled.

Information comprises one or more of: skills required of the qualified human resources; availability of the qualified human resources to handle the work item; and, subject matter expertise of the qualified human resources.

The plurality of human resources are associated with at least one of: a group having a specific skillset; a specific queue; a specific workgroup; a specific business unit; and, a logical grouping of human resources. The availability of the plurality of human resources is pulled from the personal information manager systems of the human resources.

The state change actions comprise at least one of: view list of a plurality of work items; view list of a plurality of human resources; view a single work item; and, actions performed by a human resource. The view list of a plurality of work items is periodically refreshed. The view list comprises a view of a personal queue associated with a human resource. The single work item view comprises viewing a representation of the work item that the human resource receives. The view list comprises a view of a personal queue associated with a human resource. The single work item view comprises viewing a representation of the work item that the human resource receives. Actions performed by a human resource comprise at least one of: edit work item; reschedule work item; cancel; accept work item; and, decline. The acceptance of a work item comprises assignment of the work item. The acceptance of a work item changes the state of the work item to accepted. The acceptance of a work item triggers an action item by the system. The action item comprises one or more: notifying the first party, creating calendar events, notifying the accepting human resource, and updating data associated with the work item in the system.

In yet another embodiment, a method is presented for non-linear routing of a plurality of work items, wherein a plurality of human resources are capable of concurrently processing the work items in a system across a network in an enterprise setting, the method comprising: submitting, by a plurality of parties through a user interface associated with each of the plurality of parties, a plurality of work items to a processor comprising an intelligent process automation module; collecting information related to the plurality of work items and determining the availability of qualified human resources from the plurality of human resources; entering the plurality of work items into the system if it has been determined that there is availability of qualified human resources, otherwise returning work items to the submitting parties; performing, by the plurality of human resources, state change actions to the work item, wherein the actions are performed concurrently by the plurality of human resources; comparing a last modified record timestamp for each of the plurality of human resources on the work item to a last known modified timestamp of a server for the state change action, wherein, if the values do not match, alert the human resource and force a re-evaluation of the requested state change; and updating the work item with the action until the work item has been handled.

In another embodiment, a method is presented for non-linear routing of work items, wherein a plurality of human resources are capable of concurrently processing the work items in a system across a network in an enterprise setting, the method comprising: receiving at least one work item request at a processor comprising an intelligent process automation module; notifying the plurality of human resources of the at least one work item receipt; concurrently performing, by more than one of the plurality of human resources through the intelligent process automation module, actions against the at least one work item, wherein a human resource accepts or assigns the work item to a second human resource; and wherein the human resource that accepts or assigns the work item becomes owner and the work item is removed from view of other human resources.

Stateful information of the other human resources is not affected. The other human resources can do one or more of: perform actions on the work item, perform edits to the work item, and receive notifications related to the work item.

In another embodiment, a method is presented for routing work items in a non-linear fashion in a contact center environment, wherein a plurality of human resources are capable of concurrently processing the work items in a system across a network, the method comprising: receiving at least one work item request at a processor comprising an intelligent process automation module; classifying the at least one work items with information, wherein the information comprises at least one of: agent skillset, type of transaction, and action required; notifying the plurality of human resources of the receipt of the at least one work item; concurrently performing, by more than one of the plurality of human resources through the intelligent process automation module, actions against the at least one work item, wherein a human resource accepts or assigns the work item to a second human resource; and wherein the human resource that accepts or assigns the work item becomes owner and the work item is removed from view of other human resources.

Stateful information of the other human resources is not affected. Work items might comprise back office work in the contact center environment. The other human resources can do one or more of: perform actions on the work item, perform edits to the work item, and receive notifications related to the work item.

### BRIEF DESCRIPTION OF THE DRAWINGS

FIG. 1 is a diagram illustrating an embodiment of a system for concurrent processing of work items.

FIG. 2 is a flowchart illustrating an embodiment of a process for concurrent processing of work items.

FIG. 3A is a diagram illustrating an embodiment of a computing device.

FIG. 3B is a diagram illustrating an embodiment of a computing device.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Traditional methods of routing work items, whether in a contact center or enterprise environment, do not allow for concurrent processing of these work items by a plurality of human resources. Automated call distribution style routing and group ring routing alone do not allow for the ability of a plurality of individuals to evaluate a work item or interaction without impacting the state of the overall assignment. For example, in an ACD environment, ACD routing is linear and routes from one agent to the next with the state changing against the particular interaction. In a group ring environment, state change is more simplified, and everyone is alerted to a work item. The first person to act against the work item changes the state into accepted. Neither example allows for additional routing behavior of the work item.

In an embodiment, the human resources have the ability to evaluate multiple items at the same time. All work items may be presented to each of the plurality of individuals simultaneously and allow each individual to evaluate the entire workload to properly balance the work items. Further, the evaluation of the work items allows for additional routing behavior of the work item. Additionally, a plurality of human resources are able to concurrently take action against a work item.

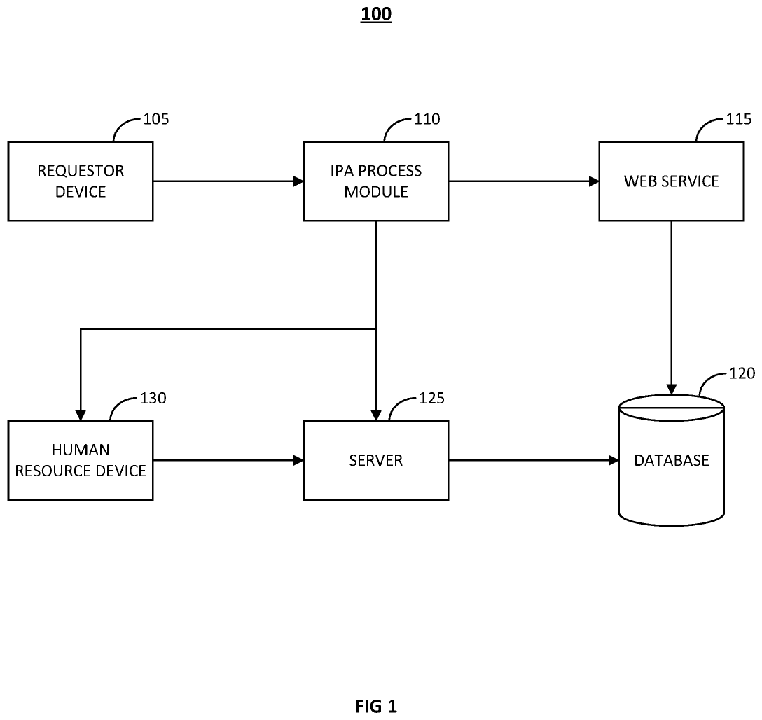

FIG. 1 is a diagram illustrating an embodiment of a system for concurrent processing of work items, indicated generally at 100. Components of the system 100 might include a device associated with a requestor 105, an intelligent process automation (IPA) module 110, a web service 115, a database 120, a server 125, and a device associated with a human resource 130. The system 100 may be utilized in a contact center environment or an enterprise environment setting.

A work item request might be initiated through a user interface located on a device associated with a requestor 105. In an embodiment, a requestor may submit a plurality of work item requests. The user interface allows the requestor to input or select information about the work item. For example, a group of consultants exist within an enterprise that specializes in product presentations to potential customers. An employee within the sales organization might request that a consultant meet with a potential customer and provide a product presentation. The employee would submit a request in the system 100. In the request, information is needed about the work item. Information, for example, might include the date and time of the presentation request, information about the third party being presented to, length of presentation, time zone of presentation, topic of presentation, etc., to name a few non-limiting examples.

The user interface accessed by the requestor's device 105 may be connected to a work item request IPA process module 110 affiliated with the user interface. In an embodiment, the module 110 communicates with a web service 115 and performs the actions taken against the work items by the requestors and/or the human resources. In an embodiment, the IPA process module may also communicate with the server 125. For example, information about actions taken by the requestor against a work item may be communicated directly with the server 125. In another embodiment, the IPA process module 110 comprises a subsystem of a server, whether it be the server 125 or a different server in the system 100.

The server 125 maintains the routing logic and communications information to the human resources' devices 130 and to the database 120. The IPA process module 110, or subsystem, comprises a communications-based process automation component of a processor which leverages existing communication and routing components in a network to facilitate the automation of business processes. In an embodiment, this can be applied to CRM systems (e.g. Salesforce) with the flexibility to integrate the process automation component.

The web service 115 may be called to handle all of the communication to the database 120. The web service 115 may also communicate with a database server 125 (which, in an embodiment, might be a CRM database) and handles the inserts, updates, and deletion of work item data stored in the database 120. A group member, or a human resource, is able to access a web page or user interface through their device 130 and is able to view work item records. Any number of devices 130 associated with human resources may be connected to the system 100, but for simplicity, only one is shown. Human resources might comprise agents in a contact center, employees in an enterprise environment setting, etc. These work item records may reside on the server 125. The database server 125 may additionally be able to provide reporting of work items. For example, metrics around the work items like presentations per consultant per time period, revenue opportunity, etc., to name a few non-limiting examples, may be provided.

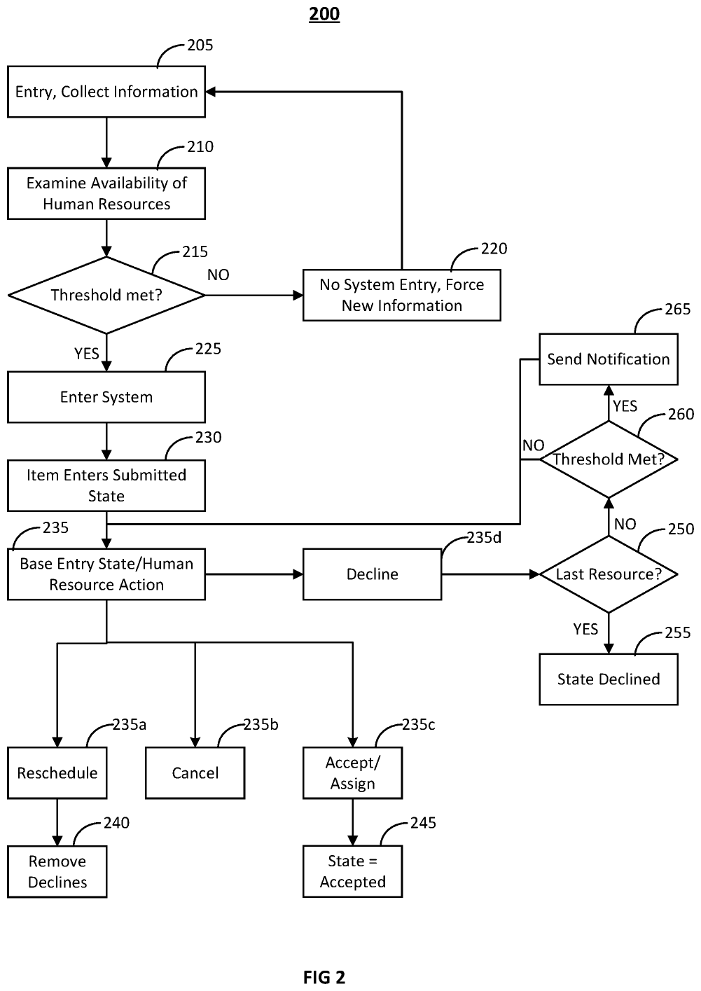

FIG. 2 is a flowchart illustrating an embodiment of a process for concurrent processing of work items, indicated generally at 200. The process 200 may occur in the concurrent processing system 100.

In operation 205, the work item enters the system. A requestor will have accessed the system 100 through a user interface associated with their device. The requestor may input a request for a work item (such as the presentation request in the example given above) and provide additional information within the user interface. Information may be collected specific to the work item. In an embodiment, information may be collected from the requestor in their user interface. In another embodiment, information may be pre-filled based on the type of work item request or pulled from a database in addition or alternatively to the requestor's input information. In an embodiment, information might comprise skills required of a human resource qualified to handle the work item, availability of the human resources to handle the work item, or subject matter expertise of a human resource qualified to handle the work item, to name a few non-limiting examples. Additionally, a requestor may input a plurality of work items into the system. A unique identifier may also be assigned to the work item request. Control is passed to operation 210 and the process 200 continues.

In operation 210, time dimension attributions are collected about the work item request. For example, a completion time may be associated with the work item. Information may be pulled from the work item request data in order to determine when the work item needs to be performed, completed, or scheduled by, for example. In an embodiment, attributes may be pulled by the IPA module, though the data ultimately lives in a system of record that can be accessed. Data may also be stored within the server which may be pulled (e.g., state data which is stored as part of the process logic). Control is passed to operation 215 and the process 200 continues.

In operation 215, it is determined whether or not there is availability of qualified human resources. If there are no qualified human resources available, control is passed to operation 220 and a new attribute may be forced on the requestor submitting the work item to the system. If it is determined that there is availability of qualified human resources, control is passed to operation 225 and the process 200 continues. Qualified human resources may comprise those human resources who belong to a specific group with a specific skillset, a specific queue, a specific workgroup, a specific business unit, or be any logical grouping of human resources.

In an embodiment, if the availability of resources dips below a specified threshold, a warning may be provided to one or both of: the human resource(s) and the requestor. For example, one or more human resources within the group can know if many others within the group have already declined. The requestor may also receive this information. In an embodiment, the notification might suggest alternate times with greater availability to the requestor. The determination of availability of human resources may be determined by pulling information about the human resources from their personal information manager (e.g., Microsoft Outlook).

In operation 220, for example, the requestor may receive a notification that their work item request needs to be modified. There may be attributes that are not possible entered into the request by the requestor and as such, need to be corrected in order to pass the work item through the system. In an embodiment, when all of the human resources decline a request, the requestor receives a notification that no one is available, but the requestor can go in to the system and request new times. If the requestor updates the work item, the routing starts again with the same unique identifier assigned to the work item request, but the routing process is restarted. The requestor has the ability to continually change times and dates and access the record.

In operation 225, if it has been determined that there is availability of human resources, the work item can be entered (or submitted) into the processing system. The work item data may be stored in a database where it is able to be accessed by the plurality of human resources. Control is passed to operation 230 and the operation 200 continues.

In operation 230, a submitted state is entered of the work item. The system 100 pulls the possible human resources and any data that may be needed. For example, the web service 115 may pull the possible human resources and any data from the IPA subsystem running on the server 125. In another embodiment, if the process is utilizing a CRM system, an external webservice can access the CRM for processing. Calendar events of the human resources may be accessed and declines may be compared or created based on conflicting events. Notifications may be sent to the plurality of human resources who are able to perform actions on the work items, the requestor, and/or any human resource who subscribes to notifications from the system 100. Control is passed to operation 235 and the process 200 continues.

In operation 235, the work item enters a base submitted state. For example, the base submitted state allows for actions to be performed on the work item by a plurality of individuals. The plurality of individuals comprise a logical grouping of human resources, such as employees in an enterprise environment setting having a specific skillset to handle the work item, to name a non-limiting example. Other examples might include human resources belonging to specific: queues, workgroups, or business units.

In an embodiment, the human resources may receive a representation of a work item, which is edited. For example, a reschedule 235a, cancel 235b, accept/assign 235c, or decline 235d to name a few nonlimiting examples. An action might allow the human resource to view their list (e.g., time interval-based refreshing of human resources available work item), view work items, and edit work items, for example.

Editing work items allows a human resource to create field changes and tied records. In an embodiment, rescheduling of the work item allows for the removal of declines 240 and the work item returns to the submitted state 230. Accept/Assign 235c updates the owner appropriately and moves the state to accepted 245. The requestor who submitted the original work item is notified and calendar events may be created around the work item.

In operation 235d, the work item has been declined by one or more of the human resources. A decision may be made to determine whether there are any other available human resources or if the declining human resource was the last resource available 250. Declines are gathered against the work item. If there are no other human resources available, the state of the work item may be set to decline 255. If there are other human resources available, in an embodiment, a warning may be created 265 if the availability of human resources has fallen below a specified a threshold 260. For example, if the availability of human resources has become less than 30%, a warning may be created and sent.

In an embodiment, the grouping of human resources comprises a group of consultants within a business unit. These consultants are able to evaluate and take action against one or more work items that enter the system 100. In this example, the work item might be a request for a presentation. The request is received by the group through the system and information can be examined related to the request by several of the consultants at the same time. Action may be taken by multiple of the plurality of consultants at the same time with the request being updated with these actions simultaneously. Each of the consultants may review the request as it is received or at some later point in time and perform some action on this work item. One of the consultants, Charles, may decline the request because he has other work to do. Jason, as the consultant group leader, may examine the request and decide to assign it to Jaclyn, another group member, because he doesn't feel like handling the work item. Another member of the consultant group may modify the request while yet another member may decide that they would like to accept the request. Once the request has been accepted or assigned, the acceptor or assignor becomes the owner. A meeting invitation may be automatically generated through a personal information manager such as Microsoft Outlook. The meeting invitation might include information specific to the work item, including any call-in information, meeting rooms (including virtual meeting information), etc. In this example, Jason has become the owner due to assignment to another party. The request is then removed from the view of the other workers. The request may also be removed from the view of the decliner, however, once the request has been removed from view, the consultants may still be able to access the request and perform actions on it (based on permissions). Requestors (those who submitted a request into the system for a presentation) may also be able to make edits or receive notifications if they choose.

In an embodiment, the database might comprise a CRM database. For example, the CRM database might comprise a solution such as that offered by Salesforce. In this example, the consultants are able to see requests that come into a queue. The queue will show all active and pending presentation requests to each consultant based on their actions. Each user may have a different view of the system 100 queue. In an embodiment, this view might be their personal queue of work items. The view may be such that what the user is viewing is periodically refreshed. A user may be able to select an action from the work item (e.g., decline, accept or assign, reschedule, cancel, etc., to name a few non-limiting examples). A request may be reviewed by a user where the user may edit items. Details may also be listed pertaining to the item so that the user can determine what action to take. A user may also be able to view the history of the item related to it with real-time feedback available. In the event that two or more users take an action at the same time on the same work item, the first conflicting action is committed and the others are denied with notification. The routing may be performed in the CRM solution through a combination of relational database tables. Stored procedures may be used to create transactions allowing atomic changes to the tables' state. A list of declines may also be created for each work item. Based on the count of the decline entries in comparison to available resources, a work item may move from the state of accepted to decline.

In an embodiment, each state change action compares the human resource's last modified record timestamp to the server's known last modified timestamp. If the values do not match, the human resource receives a warning that the record has changed state and forces re-evaluation of the requested state change.

Another embodiment may be applied to a contact center scenario for the routing of work items to agents, for example, routing of work items to upper level support for highly skilled subject matter experts offering input for an issue. Multiple experts may receive a work item at the same time to expedite a solution and receive multiple inputs without having to do multiple agent transfers. As opposed to an escalation methodology, a collaborate effort results. Work items might also comprise back office work for contact center agents, such as email, social media postings, forum responses, etc. A work item(s) might be received in the system 100 and classified with information such as the skillset of the agent required to handle the item, the type of transaction (difficulty, media type, etc.), and the type of action required (e.g, a follow-up or a simple response). A plurality of human resources may be notified of the receipt of the work items. These human resources may be agents of a specific group or those who may simply be free to handle the work item. The work item(s) may be viewed by all human resources targeted instead of just one and any of the human resources can perform action against the request concurrently with other human resources, resulting a collaborative working structure for more difficult tasks. Actions might comprise decline, assign or accept. A decline removes the request from view of the human resource that declines, however a decline does not preclude the human resource from taking subsequent actions against that work item or receiving notifications related to it.

Computer Systems

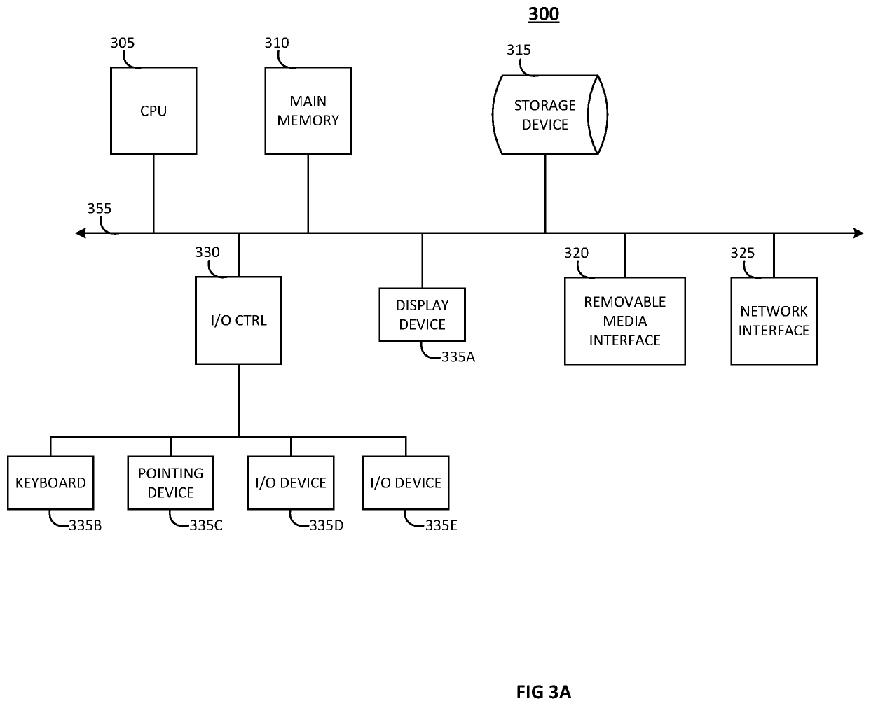

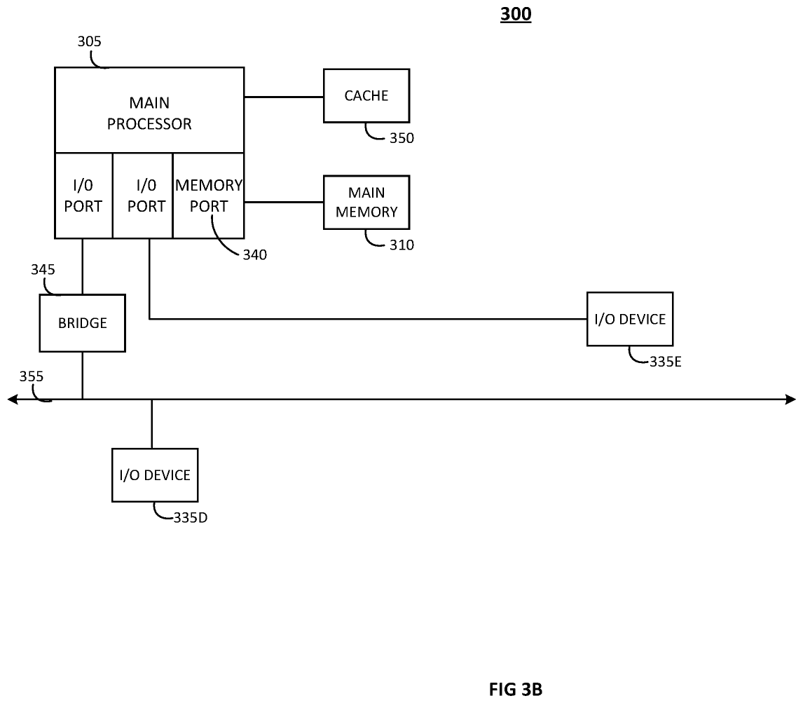

In an embodiment, each of the various servers, controls, switches, gateways, engines, and/or modules (collectively referred to as servers) in the described figures are implemented via hardware or firmware (e.g., ASIC) as will be appreciated by a person of skill in the art. Each of the various servers may be a process or thread, running on one or more processors, in one or more computing devices (e.g., FIGS. 3A, 3B), executing computer program instructions and interacting with other system components for performing the various functionalities described herein. The computer program instructions are stored in a memory which may be implemented in a computing device using a standard memory device, such as, for example, a RAM. The computer program instructions may also be stored in other non-transitory computer readable media such as, for example, a CD-ROM, a flash drive, etc. A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JSON.

FIGS. 3A and 3B are diagrams illustrating an embodiment of a computing device as may be employed in an embodiment of the invention, indicated generally at 300. Each computing device 300 includes a CPU 305 and a main memory unit 310. As illustrated in FIG. 3A, the computing device 300 may also include a storage device 315, a removable media interface 320, a network interface 325, an input/output (I/O) controller 330, one or more display devices 335A, a keyboard 335B and a pointing device 335C (e.g., a mouse). The storage device 315 may include, without limitation, storage for an operating system and software. As shown in FIG. 3B, each computing device 300 may also include additional optional elements, such as a memory port 340, a bridge 345, one or more additional input/output devices 335D, 335E, and a cache memory 350 in communication with the CPU 305. The input/output devices 335A, 335B, 335C, 335D, and 335E may collectively be referred to herein as 335.

The CPU 305 is any logic circuitry that responds to and processes instructions fetched from the main memory unit 310. It may be implemented, for example, in an integrated circuit, in the form of a microprocessor, microcontroller, or graphics processing unit, or in a field-programmable gate array (FPGA) or application-specific integrated circuit (ASIC). The main memory unit 310 may be one or more memory chips capable of storing data and allowing any storage location to be directly accessed by the central processing unit 305. As shown in FIG. 3A, the central processing unit 305 communicates with the main memory 310 via a system bus 355. As shown in FIG. 3B, the central processing unit 305 may also communicate directly with the main memory 310 via a memory port 340.

In an embodiment, the CPU 305 may include a plurality of processors and may provide functionality for simultaneous execution of instructions or for simultaneous execution of one instruction on more than one piece of data. In an embodiment, the computing device 300 may include a parallel processor with one or more cores. In an embodiment, the computing device 300 comprises a shared memory parallel device, with multiple processors and/or multiple processor cores, accessing all available memory as a single global address space. In another embodiment, the computing device 300 is a distributed memory parallel device with multiple processors each accessing local memory only. The computing device 300 may have both some memory which is shared and some which may only be accessed by particular processors or subsets of processors. The CPU 305 may include a multicore microprocessor, which combines two or more independent processors into a single package, e.g., into a single integrated circuit (IC). For example, the computing device 300 may include at least one CPU 305 and at least one graphics processing unit.

In an embodiment, a CPU 305 provides single instruction multiple data (SIMD) functionality, e.g., execution of a single instruction simultaneously on multiple pieces of data. In another embodiment, several processors in the CPU 305 may provide functionality for execution of multiple instructions simultaneously on multiple pieces of data (MIMD). The CPU 305 may also use any combination of SIMD and MIMD cores in a single device.

FIG. 3B depicts an embodiment in which the CPU 305 communicates directly with cache memory 350 via a secondary bus, sometimes referred to as a backside bus. In other embodiments, the CPU 305 communicates with the cache memory 350 using the system bus 355. The cache memory 350 typically has a faster response time than main memory 310. As illustrated in FIG. 3A, the CPU 305 communicates with various I/O devices 335 via the local system bus 355. Various buses may be used as the local system bus 355, including, but not limited to, a Video Electronics Standards Association (VESA) Local bus (VLB), an Industry Standard Architecture (ISA) bus, an Extended Industry Standard Architecture (EISA) bus, a Micro Channel Architecture (MCA) bus, a Peripheral Component Interconnect (PCI) bus, a PCI Extended (PCI-X) bus, a PCI-Express bus, or a NuBus. For embodiments in which an I/O device is a display device 335A, the CPU 305 may communicate with the display device 335A through an Advanced Graphics Port (AGP). FIG. 3B depicts an embodiment of a computer 300 in which the CPU 305 communicates directly with I/O device 335E. FIG. 3B also depicts an embodiment in which local buses and direct communication are mixed: the CPU 305 communicates with I/O device 335D using a local system bus 355 while communicating with I/O device 335E directly.

A wide variety of I/O devices 335 may be present in the computing device 300. Input devices include one or more keyboards 335B, mice, trackpads, trackballs, microphones, and drawing tables, to name a few non-limiting examples. Output devices include video display devices 335A, speakers and printers. An I/O controller 330 as shown in FIG. 3A, may control the one or more I/O devices, such as a keyboard 335B and a pointing device 335C (e.g., a mouse or optical pen), for example.

Referring again to FIG. 3A, the computing device 300 may support one or more removable media interfaces 320, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 335 may be a bridge between the system bus 355 and a removable media interface 320.

The removable media interface 320 may, for example, be used for installing software and programs. The computing device 300 may further include a storage device 315, such as one or more hard disk drives or hard disk drive arrays, for storing an operating system and other related software, and for storing application software programs. Optionally, a removable media interface 320 may also be used as the storage device. For example, the operating system and the software may be run from a bootable medium, for example, a bootable CD.

In an embodiment, the computing device 300 may include or be connected to multiple display devices 335A, which each may be of the same or different type and/or form. As such, any of the I/O devices 335 and/or the I/O controller 330 may include any type and/or form of suitable hardware, software, or combination of hardware and software to support, enable or provide for the connection to, and use of, multiple display devices 335A by the computing device 300. For example, the computing device 300 may include any type and/or form of video adapter, video card, driver, and/or library to interface, communicate, connect or otherwise use the display devices 335A. In an embodiment, a video adapter may include multiple connectors to interface to multiple display devices 335A. In another embodiment, the computing device 300 may include multiple video adapters, with each video adapter connected to one or more of the display devices 335A. In other embodiments, one or more of the display devices 335A may be provided by one or more other computing devices, connected, for example, to the computing device 300 via a network. These embodiments may include any type of software designed and constructed to use the display device of another computing device as a second display device 335A for the computing device 300. One of ordinary skill in the art will recognize and appreciate the various ways and embodiments that a computing device 300 may be configured to have multiple display devices 335A.

An embodiment of a computing device indicated generally in FIGS. 3A and 3B may operate under the control of an operating system, which controls scheduling of tasks and access to system resources. The computing device 300 may be running any operating system, any embedded operating system, any real-time operating system, any open source operation system, any proprietary operating system, any operating systems for mobile computing devices, or any other operating system capable of running on the computing device and performing the operations described herein.

The computing device 300 may be any workstation, desktop computer, laptop or notebook computer, server machine, handled computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 300 may have different processors, operating systems, and input devices consistent with the device.

In other embodiments, the computing device 300 is a mobile device. Examples might include a Java-enabled cellular telephone or personal digital assistant (PDA), a smart phone, a digital audio player, or a portable media player. In an embodiment, the computing device 300 includes a combination of devices, such as a mobile phone combined with a digital audio player or portable media player.

A computing device 300 may be one of a plurality of machines connected by a network, or it may include a plurality of machines so connected. A network environment may include one or more local machine(s), client(s), client node(s), client machine(s), client computer(s), client device(s), endpoint(s), or endpoint node(s) in communication with one or more remote machines (which may also be generally referred to as server machines or remote machines) via one or more networks. In an embodiment, a local machine has the capacity to function as both a client node seeking access to resources provided by a server machine and as a server machine providing access to hosted resources for other clients. The network may be LAN or WAN links, broadband connections, wireless connections, or a combination of any or all of the above. Connections may be established using a variety of communication protocols. In one embodiment, the computing device 300 communicates with other computing devices 300 via any type and/or form of gateway or tunneling protocol such as Secure Socket Layer (SSL) or Transport Layer Security (TLS). The network interface may include a built-in network adapter, such as a network interface card, suitable for interfacing the computing device to any type of network capable of communication and performing the operations described herein. An I/O device may be a bridge between the system bus and an external communication bus.

In an embodiment, a network environment may be a virtual network environment where the various components of the network are virtualized. For example, the various machines may be virtual machines implemented as a software-based computer running on a physical machine. The virtual machines may share the same operating system. In other embodiments, different operating system may be run on each virtual machine instance. In an embodiment, a “hypervisor” type of virtualizing is implemented where multiple virtual machines run on the same host physical machine, each acting as if it has its own dedicated box. The virtual machines may also run on different host physical machines.

Other types of virtualization are also contemplated, such as, for example, the network (e.g., via Software Defined Networking (SDN)). Functions, such as functions of session border controller and other types of functions, may also be virtualized, such as, for example, via Network Functions Virtualization (NFV).

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for non-linear routing of work items, wherein a plurality of human resources are capable of concurrently processing the work items in a system across a network in an enterprise setting, the method comprising:
submitting, by a first party through a user interface, a work item to a processor comprising an intelligent process automation module;
collecting information related to the work item and determining the availability of qualified human resources from the plurality of human resources;
entering the work item into the system if it has been determined that there is availability of qualified human resources, otherwise returning the work item to the first party;
performing, by the plurality of human resources, state change actions to the work item, wherein the actions are performed concurrently by the plurality of human resources;
comparing a last modified record timestamp for each of the plurality of human resources on the work item to a last known modified timestamp of a server for the state change action, wherein, if the values do not match, alert the human resource and force a re-evaluation of the requested state change; and
updating the work item with the action until the work item has been handled.

2. The method of claim 1, wherein the information comprises one or more of: skills required of the qualified human resources; availability of the qualified human resources to handle the work item; and
subject matter expertise of the qualified human resources.

3. The method of claim 1, wherein the availability of qualified human resources is compared against a threshold and if there is no availability, the work item is returned to the first party for selection of a new attribute.

4. The method of claim 1, wherein the availability of qualified human resources is compared against a threshold and if it does not meet a threshold, a notification is generated to one or more of the: first party and the plurality of human resources.

5. The method of claim 1, wherein the plurality of human resources are associated with at least one of: a group having a specific skillset; a specific queue; a specific workgroup; a specific business unit; and, a logical grouping of human resources.

6. The method of claim 1, wherein the availability of the plurality of human resources is pulled from the personal information manager systems of the human resources.

7. The method of claim 1, wherein the state change actions comprise at least one of: view list of a plurality of work items; view list of a plurality of human resources; view a single work item; and, actions performed by a human resource.

8. The method of claim 7, wherein the view list of a plurality of work items is periodically refreshed.

9. The method of claim 7, wherein the view list comprises a view of a personal queue associated with a human resource.

10. The method of claim 7, wherein the single work item view comprises viewing a representation of the work item that the human resource receives.

11. The method of claim 7, wherein the actions performed by a human resource comprise at least one of: edit work item; reschedule work item; cancel; accept work item; and, decline.

12. The method of claim 11, wherein the acceptance of a work item comprises assignment of the work item.

13. The method of claim 12, wherein the acceptance of a work item changes the state of the work item to accepted.

14. The method of claim 12, wherein the acceptance of a work item triggers an action item by the system.

15. The method of claim 14, wherein the action item comprises one or more: notifying the first party;
creating calendar events; notifying the accepting human resource; and, updating data associated with the work item in the system.

16. A system for non-linear routing of work items, wherein a plurality of human resources are capable of concurrently processing the work items in a system across a network in an enterprise setting, the method comprising:
a processor, comprising an intelligent process automation module to which a work item is submitted by a first party through a user interface; and,
a memory in communication with the processor, the memory storing instructions that, when executed by the processor, causes the processor to:
collect information related to the work item and determine the availability of qualified human resources from the plurality of human resources;
enter the work item into the system if it has been determined that there is availability of qualified human resources, otherwise returning the work item to the first party;
perform state change actions to the work item, wherein the actions are performed concurrently by the plurality of human resources;
compare a last modified record timestamp for each of the plurality of human resources on the work item to a last known modified timestamp of a server for the state change action, wherein, if the values do not match, alert the human resource and force a re-evaluation of the requested state change; and
update the work item with the action until the work item has been handled.

17. The system of claim 16, wherein the information comprises one or more of: skills required of the qualified human resources; availability of the qualified human resources to handle the work item;
and, subject matter expertise of the qualified human resources.

18. The system of claim 16, wherein the plurality of human resources are associated with at least one of: a group having a specific skillset; a specific queue; a specific workgroup; a specific business unit; and, a logical grouping of human resources.

19. The system of claim 16, wherein the availability of the plurality of human resources is pulled from the personal information manager systems of the human resources.

20. The system of claim 16, wherein the state change actions comprise at least one of: view list of a plurality of work items; view list of a plurality of human resources; view a single work item; and, actions performed by a human resource.

21. The system of claim 20, wherein the view list of a plurality of work items is periodically refreshed.

22. The system of claim 20, wherein the view list comprises a view of a personal queue associated with a human resource.

23. The system of claim 20, wherein the single work item view comprises viewing a representation of the work item that the human resource receives.

24. The system of claim 20, wherein the actions performed by a human resource comprise at least one of: edit work item; reschedule work item; cancel; accept work item; and, decline.
